(19) United States
(12) Patent Application Publication
(10) Pub. No.: US 2006/0175485 A1
(43) Pub. Date: Aug. 10, 2006

(54) Pivoting head system in particular for film and video cameras

(76) Inventor: Sebastian Cramer, Muenchen (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/562,966

(22) PCT Filed: Jun. 23, 2004
(86) PCT No.: PCT/EP04/06796

§ 371 Date: Dec. 29, 2005

(30) Foreign Application Priority Data
Jun. 25, 2003 (DE) 203 09 857.9

(51) Int. Cl. F16M 11/14

(52) U.S. Cl. 248/184.1; 248/183.2

(57) ABSTRACT

The invention relates to a pan headcamera head system having a panning apparatus (1, 1a, 1b, 1c) for carrying out vertical tilting movements and/or horizontal panning movements of a camera, in particular a movie film or video camera. Here, the panning apparatus (1, 1a, 1b, 1c) is fitted in or on a substantially flat holding element (5) on which there are fitted at an angular spacing about an imaginary vertical axis (A) at least three casters (2) rotating respectively about a horizontal caster axle (3). It is possible here for at least one of the caster axles (3) to rotate and to be fixed in a horizontal plane, this having at least one running direction adjusting device (11, 11a, 11b, 12, 13, 14, 15, 16, 16i, 17) for adjusting the rotary position.

### CROSS REFERENCE TO RELATED APPLICATION

This application is a National Phase of International Application Serial No. PCT/EP2004/006796, filed Jun. 23, 2004.

### BACKGROUND OF THE INVENTION

1. Field of the Invention

The invention relates to a camera head system, in particular for film or video cameras, and to a guide system that comprises the camera head system.

2. Description of the Background Art

It is known that when taking movie and video pictures the panning and tilting angles of a camera are adjusted with the aid of a camera head that can be mounted for static pictures on a tripod, and for camera tracking movements on a camera vehicle, mostly a dolly, that is described in DE 3236837 C2 or in WO 99/51911 A1.

These commercially available camera dollies usually have four casters or 4 pairs of casters on which there rests a frame that supports a lifting column or a lifting arm. Located on the top side of such a lifting or supporting device there is normally an interface that is capable of being connected to a commercially available camera head.

The above-named camera dollies are designed such that the camera operator and his assistant both sit or stand on the dolly and usually will be moved together with the camera. In most cases, for this purpose additional colleagues are required to push the dolly, as a result of which the coordination of an organic camera movement is rendered difficult in part since panning movement and tracking of the dolly are executed by different persons. In some applications, for example in macro photography, the aim is frequently to execute only very small, precise camera movements, or to guide the camera directly over a surface, where a camera dolly of such a large type proves to be a disadvantage. Without further aids, the lowest height of a camera lens that can be achieved with such dollies with a mounted camera head thereon is frequently one meter and more above the ground.

In order to bring a camera into the desired position given such a formulation of the problem, it is mostly necessary to mount additional extension arms between the camera dolly and the camera head.

Likewise known are camera cranes such as, for example, the camera crane configuration that is presented in DE 3804463 A1 which shows a boom arm, on which a camera head can also be mounted upside down in a hanging configuration, to allow a camera to be guided closely over a surface, for example. However, these systems are mostly still of larger design than camera dollies and, as in the case shown above, are frequently even mounted on the middle column of a dolly. Because of their customary overall size, camera cranes therefore have similar difficulties with regard to operability and rigging complexity, as described above.

It is likewise known that tripods on which a camera head is mounted can be equipped with a rolling spreader, that is to be seen, inter alia, in DE 33 41 403 C2. These systems usually comprise three independent components: camera head, tripod and rolling spreader. Although they are of more lightweight design than a dolly, they are mostly only slightly smaller. They are generally not so well suited as dollies for accomplishing the above-named camera tasks, because the more lightweight design impairs stability and torsional strength, which means booms cannot be fastened satisfactorily.

Also known are systems which are smaller in part and in the case of which a camera head is mounted on a linearly moveable slide or a traveling plate that can be moved on linear profiles or rails of different design (DE 198 56 701 A1 and DE 198 22 778 C1). The freedom of movement of the camera is frequently restricted by the rigid guidance on a linear rail. Particularly in the case of manually guided configurations, camera head and slide are separate components of mostly different manufacturers, as a rule. By designing these two components as two separate units that are mostly connected via an interface (explained in more detail below), it is scarcely possible to achieve an optimum overall size, or to achieve a panning apparatus that can be effectively guided and is compact and can be tracked.

With these linearly guided slides, just like the movement of the slide the panning movement and tilting movement of a camera are frequently controlled exclusively by motors, as is so in the case of patent specification DE 198 22 778 C1 cited twice, and this restricts the ability of the cameraman to intervene directly.

Essentially two standards have become established worldwide as customary interfaces between a camera head and supporting devices, in particular for professional film cameras: firstly, a hemispherical, convex camera head underside with a diameter of mostly 150 mm that is fastened in a corresponding concave, upwardly open bowl, and secondly a plate with various centering rings in which a device for leveling the holding plate is frequently integrated. On their own, these interfaces have in part a not inconsiderable overall size, and are extended through standardized pivots, extension arms and tubes that likewise do not contribute to keeping a camera design small and flat.

### SUMMARY OF THE INVENTION

The present invention is therefore based on the object of employing means of simple design to provide a flexible camera head system with a small overall size that can be tracked precisely.

This object is achieved by means of a camera head system as disclosed herein.

The advantages achieved with the aid of the invention consist, in particular, in providing a unit of particularly small and flat design comprising a camera head that at the same time can be tracked. This system protrudes less and moves substantially less mass than is possible with the current prior art.

Thus, a cameraman is offered the option of independently controlling the movement of the camera and of not being dependent on the aid of colleagues or drive motors when tracking the camera. The flat design of the invention also, for example, makes it easier to take shots where the aim is for a camera to glide just above the ground.

A range of camera applications can therefore be carried out more quickly, more precisely and more cost-effectively, and also the costs in producing and procuring such a camera head system may be substantially less than what is required to be applied for the commercially available components previously required.

The development disclosed herein permits the casters to be locked, and thus enables a possibility of tracking to be blocked. As a result, the camera head system can be used for film and video cameras as a pure camera head of particularly flat design.

By virtue of the development disclosed herein, the casters can have an adjustable friction which can be advantageous for smooth tracking movement, particularly owing to the option of damping this friction. Again, the panning and tilting bearings of most camera camera heads are equipped as a rule with such damping that facilitates the execution of smooth panning movements for the cameraman. This resistance that can be felt in panning movements is extended to the tracking movement by the development disclosed herein.

The development disclosed herein renders it possible for the camera head system on the point of support to be raised or lowered with reference to the bearing surface, and for this setting to be locked. It is possible by coordinating the height adjustment of all the casters to bring the camera head system level even when the underlying surface is not. A spirit level that is usually fitted on a camera head is useful for this purpose.

The caster axle can be supported in a particularly flat design as a result of the development as disclosed herein.

The development disclosed herein simplifies the alignment of all the caster axles in a horizontal plane at an arbitrary point, thus enabling circular movements.

The development disclosed herein ensures that the casters are aligned automatically in the direction of movement, and therefore also that controllable steering movements are possible.

The development disclosed herein provides a guide rod that permits a cameraman to operate even in an upright posture when the camera head system is used on the floor, for example. In addition, it can facilitate guidance to inaccessible objects.

The development disclosed herein not only permits the camera head system to be tracked on a surface with a preadjusted direction, but also permits the track of such a tracking movement to be precisely fixed with the aid of a guide system, and thus to be rendered precisely repeatable.

### BRIEF DESCRIPTION OF THE DRAWINGS

The invention is explained in more detail below with the aid of the drawings, in which:

FIG. 1 shows a diagram of a camera head system with three casters and an L-shaped camera holder;

FIG. 2 shows a diagram of a camera head system with three casters and a rocker-type camera holder;

FIG. 3 shows a diagram of a camera head system with a U-shaped holding element and an L-shaped camera holder;

FIG. 4 shows a diagram of a camera head system with three casters and a removeable camera head;

FIG. 5 shows a diagram of the camera head system from FIG. 4 with removed camera head;

FIG. 6 shows a plan view of a caster and of its bearing in the holding element with scale and markings;

FIG. 7 shows a plan view of two casters arranged parallel to one another, and their bearing in the holding element, with a setting wheel and a digital display;

FIG. 8 shows a diagram of a push-on laser direction-finding device;

FIG. 9 shows a diagram of a push-on direction-finding device with rear and front sights and an elongation tube;

FIG. 10 shows a schematic of a circular movement about a point;

FIG. 11 shows a schematic of a circular movement about a point with the aid of three positioning motors that are connected to a CPU via cables;

FIG. 12 shows a sectional illustration through a caster bearing with a supporting tube;

FIG. 13 shows a sectional illustration through a caster bearing with a supporting tube of elongated design;

FIG. 14 shows a diagram of a supporting tube with possible locking devices;

FIG. 15 shows a schematic side view of two camera rockers together with guide rollers;

FIG. 16 shows a diagram of a camera head system with two casters running in a flat, straight guide;

FIG. 17 shows a diagram of a camera head system with two casters running in a flat, curved guide;

FIG. 18 shows a diagram of a camera head system with two casters running in a guide of higher design, and a caster supported in an elongated supporting tube;

FIG. 19 shows a diagram of a camera head system with three casters running in a double rail;

FIG. 20 shows a schematic plan view of a caster in the case of which the vertically running axis for the rotation of the caster axle in the horizontal plane does not lie in the center of the caster;

FIG. 21 shows a diagram of a caster arrangement in the case of which the caster lies outside the holding element with the aid of a horizontal axle holder;

FIG. 22 shows a schematic of a steering movement that has two mutually parallel casters locked in their horizontal rotation, and a caster that can move freely in its horizontal rotation and is located outside the holding element;

FIG. 23 shows a schematic of a steering movement that has a caster, aligned in the direction of movement and locked in its horizontal rotation, and two casters that can move freely in their horizontal rotation and are located outside the holding element;

FIG. 24 shows a diagram of a camera head system with a guide rod mounted thereon, and

FIG. 25 shows a diagrammatic exploded drawing displaying a removed fastening column together with L-shaped camera holder, a column block, a holding element with casters and a horizontal bearing ring, as well as a horizontal panning module.

### DETAILED DESCRIPTION OF THE PREFERRED EMBODIMENTS

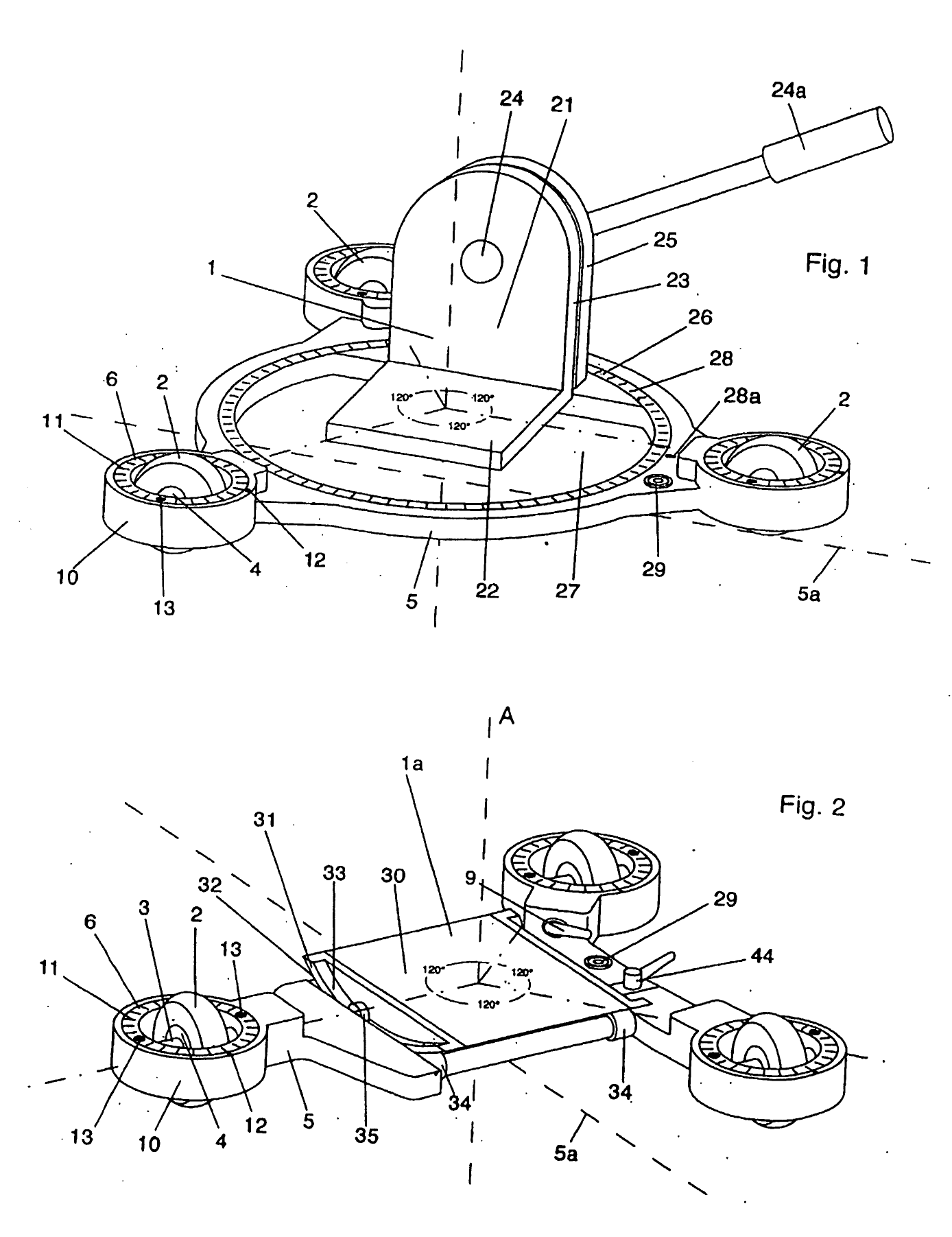

In accordance with FIGS. 1, 2, 3 and 4, possible embodiments of the camera head system according to the invention have a panning apparatus 1, 1a, 1b, 1c that is fitted inside or on a holding element 5 of substantially flat design that rests on three casters 2 that are arranged at an angular spacing about an imaginary vertical axis A that runs through the holding element 5.

The casters 2 in each case rotate about a horizontal caster axle 3 that is mounted in a bearing element 6 that can rotate in a horizontal plane. In order to achieve a flat design, such a bearing element 6 is mounted rotatably in a bearing ring element 10 that is arranged on the outer surface of the holding element 5 and designed in one piece therewith.

In the examples illustrated, all the caster axles 2 can be rotated in a horizontal plane with reference to the flat holding element 5, since it is possible thereby to achieve the greatest possible freedom in the configuration of the tracking paths. However, it will already suffice to align only one caster in its running direction in order to achieve a curved movement.

Provided, but not visible in the drawing, is a locking device with the aid of which the casters 2 can be locked in the revolving direction. It is possible thereby to prevent the camera system from inadvertently rolling away. A likewise conceivable solution would be to extend one or more braking elements from the underside of the holding element 5 such that said elements come into contact with the contact area. The horizontal rotation of a caster axle 3 can likewise be locked with the aid of a brake 9. Here, all the bearing elements 6 have such a braking or locking device 9, even if FIGS. 1, 2, 3 and 4 do not show this for all the casters. Instead of a braking or locking device 9, it is also conceivable to design the friction for the horizontal rotation of the bearing element 6 with respect to the holding frame 5 to be so tight as to exclude inadvertent rotation of the running direction of a caster 2 during operation. It is likewise conceivable to implement the rotation of the bearing element 6 with respect to the holding element 5 by means of geared solutions, for example by means of a self-locking worm gear, or by means of positioning motors. It is a feature of all such solutions that the running direction of at least one caster can both be adjustable in advance and also be able to be fixed.

In order to align the casters, there is provided as running direction adjusting device a scale 11 and markings 13 that are provided on the top side of the bearing element 6, and render it possible to read off the angle of rotation of a bearing element 6 with reference to a bearing ring element 10 at a reference mark 12 on the top side of the bearing ring element 10, the reference marks 12 being provided such that an imaginary line between the caster center and reference mark 12 runs parallel to the main orientation 5a of the camera head system.

The panning and tilting apparatus 1 shown in FIG. 1 has an L-shaped holder 21 on whose horizontal limb 22 it is possible to fasten a camera whose optical axis is aligned parallel to the side wall of the L-shaped holder 21.

Tilting movements of the camera are possible by rotating the L-shaped holder 21 about a horizontal axis with the aid of a holding bearing 24 with reference to a perpendicular fastening column 25. It is customary for this purpose to connect a pivoting arm 24a to a central shaft in the holding bearing 24 such that force is transmitted to the L-shaped holder.

Once adjusted, a tilt should be advantageous and also usually lockable. The rotation between the L-shaped holder 21 and the fastening column 25 can have an adjustable friction that is advantageously provided with damping, as is customary in the case of commercially available camera heads with fluid damping.

Panning movements of a camera are achieved in the design illustrated here by virtue of the fact that a horizontally lying bearing ring 26 on which the fastening column 25 is mounted vertically in a fixed fashion is supported rotatably in the holding element 5. In this case, the horizontal panning apparatus 1 is fitted directly in the holding element 5 in order to achieve the lowest possible camera mounting surface.

Again, it should be possible for a horizontal panning movement advantageously to be lockable and to have an adjustable friction that can be provided with damping, as is customary in the case of commercially available camera heads with fluid damping.

Something which is also known and advantageous in the case of camera heads with an L-shaped camera holder 21 is an adjusting device with the aid of which the length of the vertical limb 23 of such a holder 21 can be adjusted and locked, as a result of which the height of a camera lens can be varied with reference to the contact area. As is likewise known, another possibility for varying the height of the lens consists in designing the fastening column 25 such that its design height can be adjusted and locked, as a result of which the L-shaped holder 21 can be brought into a higher or lower position. These features, which are of no closer interest with regard to their detailed design, are also not illustrated in more detail in FIG. 1.

The horizontal bearing ring 26 has in its interior a relatively large annular opening 27 that enables the L-shaped holder 21 and/or the mounted camera to pan, or partially pan, through, and thus permits a camera position that is particularly low. It is possible thereby to achieve a mounting surface lying only a few centimeters above the contact surface of the camera head system for a camera on the horizontal limb 22 of the L-shaped holder 21. This may be a design that is flatter by approximately a factor of ten than is possible in the case of commercially available camera heads that, however, cannot be tracked at all. No upright panning arrangement is known that enables such a low camera position. Not only is a low camera position desirable here with regard to image composition—it also leads to a low center of gravity of the entire system, and this has a positive effect on the dynamic performance.

A panning scale 28 provided on the horizontal bearing ring 26 indicates the angle of rotation of the bearing ring 26 relative to the holding element 5 at a suitable reference point 28a. A spirit level 29 fitted on the top side of the holding element 5 shows whether the unit is level.

For the purpose of linear tracking of a camera head system, the scale 11 can be used to adjust the angles of rotation of all the bearing elements 6 with reference to the holding element 5 to a standard value such that all the casters 2 have a parallel alignment in the direction of which the system can now be tracked. The ability of the bearing elements 6 to be rotated can be locked with the aid of a brake 9, thus preventing a preadjusted caster alignment from inadvertently being misadjusted.

The casters 2 can be locked in the revolving direction via a locking unit already mentioned above (not illustrated in FIGS. 1, 2, 3 and 4), it being possible thereby to prevent the system from being inadvertently tracked. Alternatively, a braking element (likewise not illustrated) has already been mentioned that can be extended from the holding element 5 and can be moved out of the underside of the holding element 5 such that it makes contact with the contact area and thus prevents inadvertent rolling away.

It is possible with the aid of casters 2 blocked in such a way to use the unit as a pure camera head that is of particularly flat design and with the aid of which it is possible to execute pure tilting movements and panning movements of a camera. Of course, for static pictures it is also possible to lock the possibility of panning and tilting the camera, it then being possible to take pictures with a preadjusted camera angle.

FIG. 2 shows an exemplary embodiment of a camera head system in the case of which only the tilting angle of a camera can be adjusted, and no possibility for horizontal pivoting is provided. Here, as well, the tilting apparatus 1a is installed directly in the flat holding element 5 in order to achieve a particularly low camera position. With regard to the caster arrangement and the features of its adjustability, this exemplary embodiment is identical to the previous exemplary embodiment in FIG. 1.

A camera can be mounted on a rocker 30 that respectively has laterally on its underside an arcuate guide skid 31 that rests with its convex outer surfaces 32 on two lower guide rollers 34 arranged at a spacing from one another. An upper guide roller 35 touches the concave inner surface 33 of the guide skid 31 and prevents the rocker 30 from falling out unintentionally. A predetermined tilting position of the camera can be locked with the aid of a tilting lock 44.

In this example, as well, it is possible to achieve a very low height of sixty to eighty mm between the contact area of the system and the mounting surface of a camera on the top side of the rocker 30, and this corresponds to a solution that is lower approximately by a factor of five than is possible in the case of commercially available camera heads which, however, offer no possibility of tracking.

The arrangement of particularly flat design for the panning/tilting apparatus 1 or 1a of the holding element 5 and the casters 2 is also achieved, inter alia, by consciously dispensing with known interfaces that commercially available camera heads normally have on their underside in order to be connected to further holding devices.

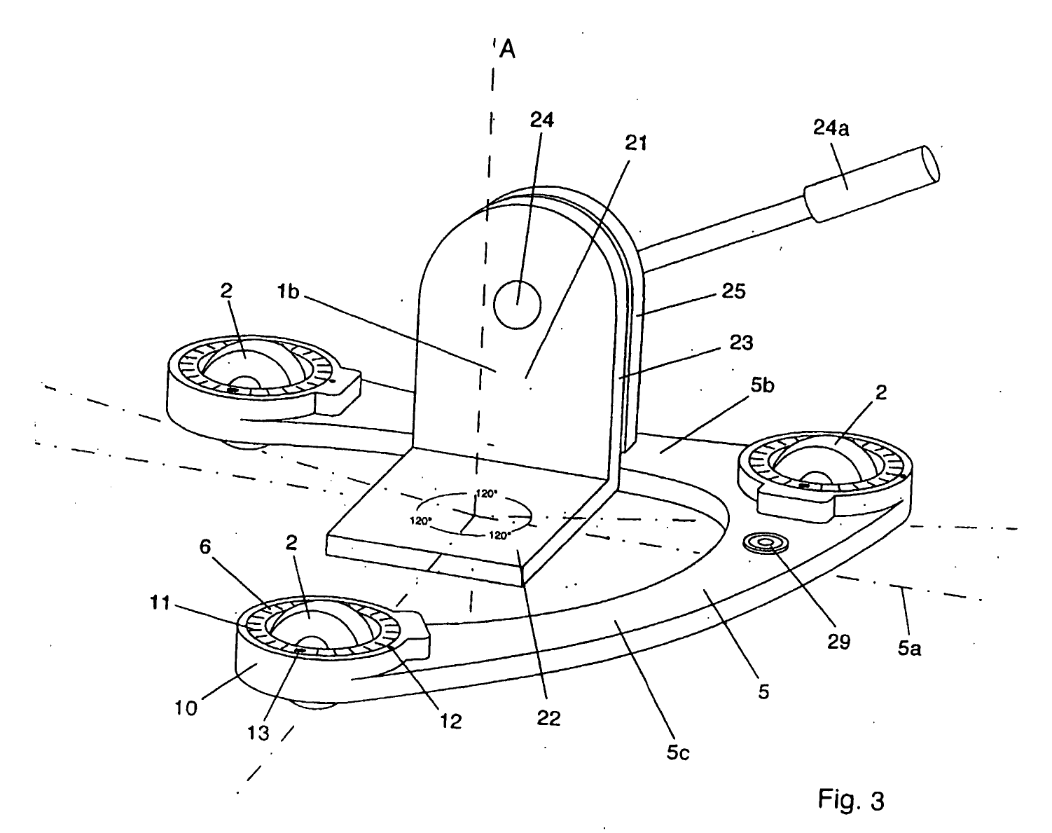

FIG. 3 shows a camera head system with an L-shaped panning apparatus 1b that is fitted on a flat U-shaped holding element 5 at whose ends and whose apex in a horizontal plane a respective caster 2 is supported in a bearing element 6. Similar to the exemplary embodiment in FIG. 2, such a system is likewise suitable only for carrying out vertical tilting movements of a camera, and does not permit any horizontal panning.

The right-hand limb, when viewed from above, of the holding element 5 is here the mounting limb 5b on which a fastening column 25 is fitted together with an L-shaped holder 21, the left-hand limb of the holding element 5 being the supporting limb 5c that has a virtually circular arcuate profile in order to ensure on the inner surface the greatest possible freedom of movement for tilting movements of the L-shaped holder 21 and of a mounted camera.

With regard to the caster arrangement and the features of its adjustability, this exemplary embodiment is identical to the two preceding configurations in FIG. 1 and FIG. 2.

As in FIG. 1, here, as well, the tilting apparatus of the L-shaped holder 21 is advantageously provided with a locking unit and a damping unit which is, however, likewise not illustrated in more detail. This design likewise has a pivoting arm 24a with the aid of which it is possible to transmit an introduction of force to the L-shaped holder 21.

Such an arrangement enables a cameraman to work with a camera height that is just as low as in the exemplary embodiment of FIG. 1, and to adjust the height of a camera lens to a height to be freely selected, doing so by adjusting the length of the vertical limb 23 or the fastening column 25. Owing to the open design of the U-shaped holding element 5, it is possible to approach extremely close to an object to be shot, if appropriate even to drive over the latter in part and to look down onto the object with a correspondingly steep tilt of the camera.

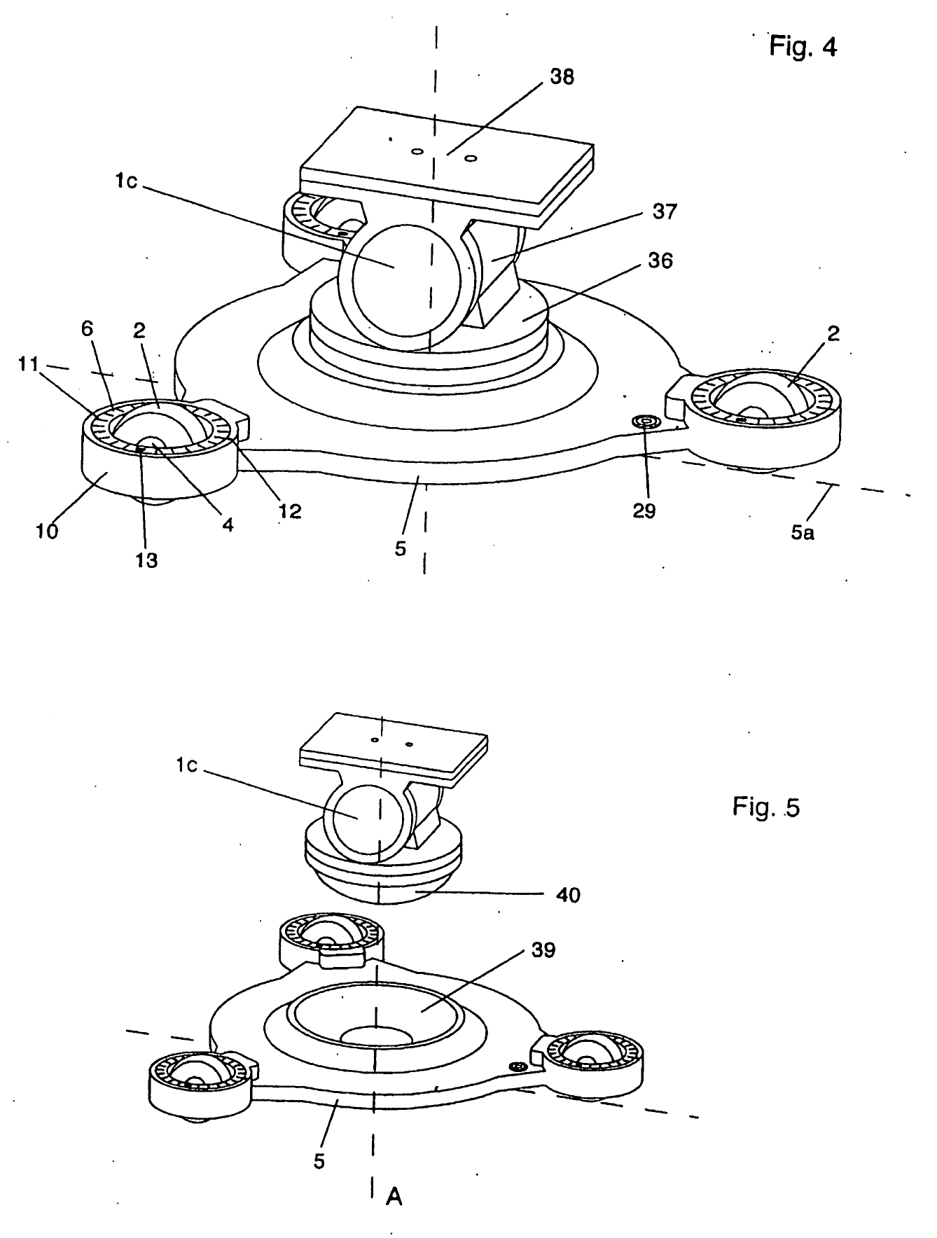

FIG. 4 and FIG. 5 show a camera head system with a removable panning/tilting apparatus 1c in mounted and removed states. Such a system has a caster arrangement like FIGS. 1, 2 and 3, with the features described there.

The panning/tilting apparatus 1c illustrated here comprises a panning module for horizontal panning movements 36, on which there is permanently mounted a tilting module for vertical tilt movements 37 on whose top side a mounting plate for cameras 38 is located. Such a design is described, for example, in US 005389972A, and is the most frequent arrangement for camera heads worldwide. Consequently, it may lead to a clear saving in costs for a user if he is able to assemble a camera head system as illustrated in FIG. 3 with a camera camera head 1c already present.

Such commercially available camera camera heads 1c usually have on their underside an interface that enables a connection with further camera support systems. In the exemplary embodiment illustrated, this interface is a convex camera head underside 40 that engages in a concave holding bowl 39 that is already integrated in the flat holding element 5 in order to achieve a particularly low camera height.

Thus, in the mounted state, the panning/tilting apparatus of the commercially available camera head 1c presses directly on the flat holding element 5 and constitutes a solution that is substantially flatter in design and protrudes much less by comparison with previously known solutions consisting of a tracking device that is mostly equipped with an additional lifting device, as well as a separate interface for holding the camera head, and a camera camera head. The advantage of such an arrangement resides in a possible saving in costs, since the user can, if appropriate, have recourse to an already existing component even if it is not possible in this configuration to implement contact areas for a camera that are so low as is possible in FIGS. 1, 2 and 3.

In addition to the spherical interface 39, 40 illustrated here between the camera head 1c and flat holding element 5, it is also possible, for example, to conceive an interface of flat design, in particular one having additional centering rings that engage in one another positively. A widespread design of such an interface is the so-called Mitchell-Mount, which likewise has worldwide numerous camera heads on its underside.

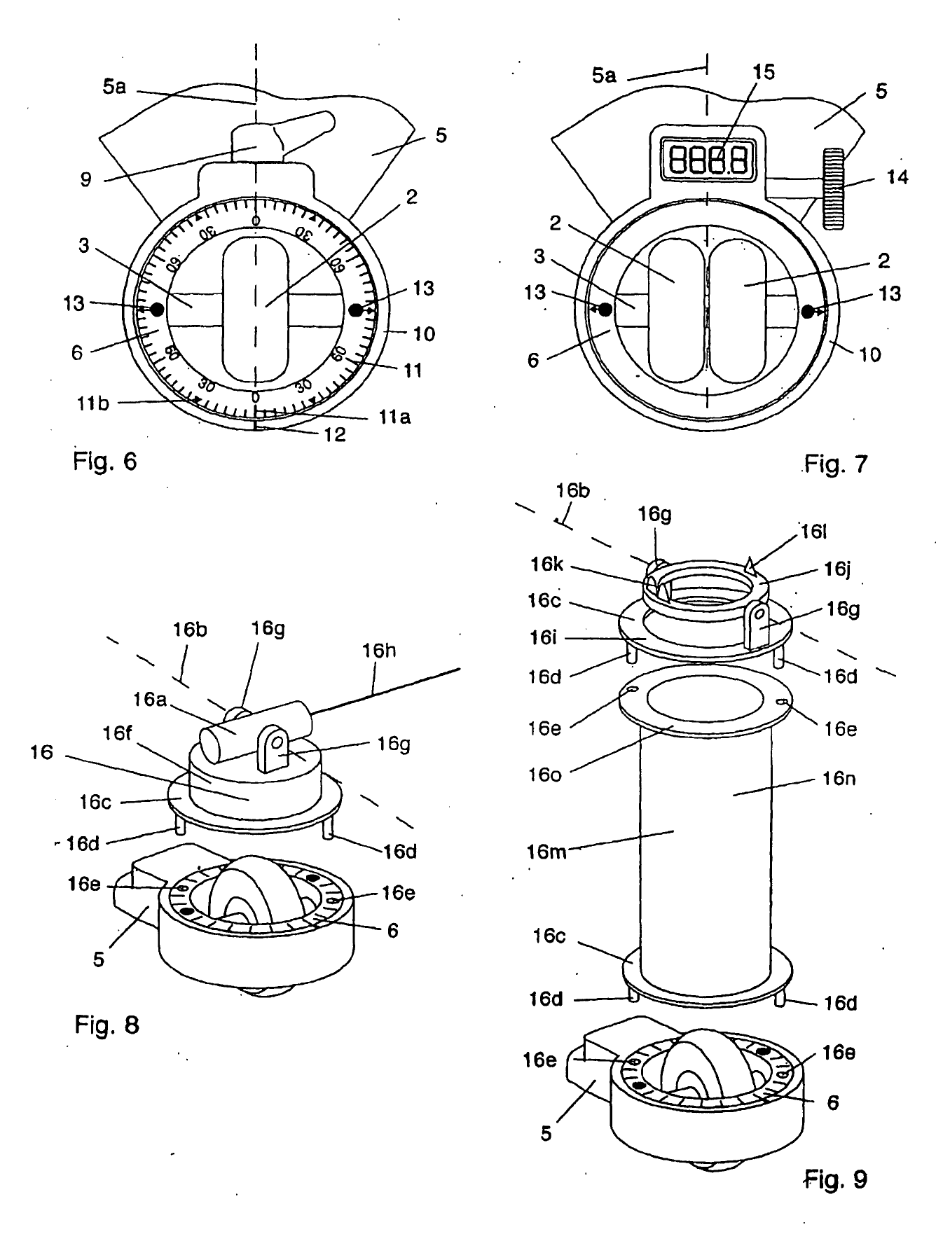

A plan view of a caster 2 is shown in FIG. 6 together with its caster axle 3 and a bearing element 6 that is supported in a bearing ring element 10 that is designed in one piece with the holding element 5. On its top side, the bearing element 6 has a running direction adjusting device in the form of a scale 11 with angular graduation showing marking strokes and numerals that are arranged in a circle. A brake 9 can clamp the bearing element 6 against the holding element 5 and lock a rotation of the caster axle 3.

A particular marking 11a indicates with reference to a reference mark 12 that the rotation of the caster axle 3 in the bearing element 6 is aligned such that the running direction of the caster 2 extends parallel to the main axis 5a of the camera head system.

Further special markings 11b are provided on the scale 11 at an angle of (30+x*60)°, x being a whole number between 0 and 5. In the configuration illustrated, these markings 11b have the shape of an isosceles triangle, and facilitate an alignment of the casters of a camera head system with three casters 2 that are arranged at an angular spacing of 120° in each case, to align these such that in each case two casters 2 lie on an identical tracking path, and the third caster 2 is aligned parallel to this tracking path, something which is helpful for using the guide profile system presented below.

Furthermore, a scale 11 shows two marking and direction-finding elements 13 that are applied perpendicularly above the caster axle 3 and have in the case illustrated the form of two points situated opposite on the bearing element 6. These marking and direction-finding elements 13 can be used to rotate the bearing element 6 such that the caster axle 3 points with its horizontal alignment to a freely selectable point in space. For this purpose, the point whose direction is to be found and the two marking and direction-finding elements 13 are brought into incidence. A position thus found can be locked with the aid of the brake 9.

10f course, it is equally well possible to fit a scale 11 on the bearing ring element 10 and to provide the bearing element 6 with a suitable reference mark at which it is possible to read off the rotary position of the caster axle 3.

FIG. 7 shows an alternative configuration of a caster arrangement and of a running direction adjusting device. In the exemplary embodiment illustrated here, two casters 2 are arranged parallel to one another at a tight spacing, the two being supported rotatably about the caster axle 3. Such an arrangement in which two or more casters 2 are arranged parallel to one another constitutes an advantage to the extent that the contact area is thereby enlarged, and a better track accuracy is therefore achieved. Likewise, instances of unevenness in the contact area are more effectively compensated by means of a number of casters. It is advantageous here when all the casters 2 are individually supported rotatably about the caster axle 3, since during cornering different circular arcs arise for the two casters 2, and therefore each caster can move on its circular arc, and this leads to an improved traction. This is also the reason as to why two or more casters 2 arranged in parallel are to be preferred to a wider contact area of a single caster 2.

The paired arrangement, described here, of two casters 2 is expedient, of course, not only in conjunction with the running direction adjusting device presented below in the form of a digital display, but can be helpful in improving the track accuracy for each exemplary embodiment.

Also illustrated in the exemplary embodiment of FIG. 7 is an alternative running direction adjusting device in the case of which a digital display 15 displays the rotary position of a bearing element 6 with reference to a bearing ring element 10. An advantageous configuration here is a display in degrees of angle, the zero position of the digital display 15 being adjusted such that a caster axle 3 is aligned horizontally rotated by 90° relative to the main orientation 5a of the camera head system. The rotary position of a bearing element 6 with reference to a bearing ring element 10 is advantageously determined here by means of an incremental encoder, preferably an absolute incremental encoder, (not illustrated), something which has the advantage that a zero position of the bearing element 6 need no longer be calibrated.

A setting wheel 14 can be used to adjust the rotation of the bearing element 6 in a horizontal plane with reference to a bearing ring element 10, a rotary movement of the setting wheel 14 being transmitted to the bearing element 6 via a gear reduction. It is conceivable, for example, that the axle of the setting wheel 14 is provided with a helical thread that engages in gear teeth of the bearing element 6. It is also possible to dispense with a brake owing to such a self-locking geared solution, since inadvertent rotation of the caster axles 3 during operation is excluded. A configuration would be advantageous here in which such an engagement of a gear in a bearing element 6 can be reversed such that a coarse horizontal rotation of the bearing element 6 is possible by hand, and the setting wheel 14 serves only for fine adjustment.

Here, as well, a bearing element 6 has special axle markings 13 that are used for the horizontal alignment of a caster axle 3 with a freely selectable point in space. Lines, protruding pins, a rear sight and front sight, a laser element, a telescope, a groove or a ring, a reticle, a transparent disk provided with a graduation, a vertical marking rod, or something similar can also be presented as further embodiments for such axle markings 13 for example. Such direction-finding elements are advantageously designed in a manner such that they can be pushed on.

Such a configuration is shown in FIG. 8, in which a direction-finding device 16 is provided with a laser element 16a that can be pivoted about a horizontal axis 16b and can be pushed onto a bearing element 6. Such a direction-finding device 16 has on the underside of its horizontal contact ring 16c two guide pins 16d that can engage in suitably designed guide bores 16e of a bearing element 6, and thus enable positionally accurate mounting. Of course, other positive connections between direction-finding element 16 and bearing element 6 are also conceivable instead of the guide pins 16d shown here.

A substantially vertical holding pot 16f open on its underside is permanently connected to the contact ring 16c. Owing to the design open on the underside, such a direction-finding device 16 can accommodate the upper region of a caster 2. Fitted on the top side of the holding pot 16f are two mutually opposite bearing cheeks 16g through which there runs a horizontally lying axle 16b that is aligned such that it is rotated by 90° relative to the caster axle 3. A laser element 16a located between the bearing cheeks 16g is supported rotatably on this axle 16b, the laser beam 16h running vertically above the center of the caster axle 3. The bearing element 6 can be rotated such that the laser beam 16h strikes any desired point in space, thus ensuring that the alignment of a caster axle 3 in its horizontal rotation points precisely to this point.

FIG. 9 shows an alternative exemplary embodiment of a push-on direction-finding device 16i in the case of which a direction-finding ring 16j situated between the bearing cheeks 16g is supported rotatably about a horizontal axis 16b that is rotated 90° relative to the caster axle 3. A rear sight 13g and a front sight 13h are fitted opposite one another on the top side of the direction-finding ring 13j in such a way that they both lie vertically above the center of the caster axle 3. The bearing element 6 can be rotated horizontally and, as just described, the direction-finding ring 16j can be tilted about the axle 16b such that the rear sight and front sight can be brought into alignment in space with any desired point. This ensures that a caster axle 3 likewise points to the point whose direction is to be found in its horizontal rotation.

On the underside of a horizontal contact ring 16c, two guide pins 16d can engage in two guide bores 16e of a bearing element 6 or of an elongation tube 16m, and ensure a positionally accurate mounting, as in FIG. 8.

It is then also possible with the aid of an elongation tube 16m to align a caster axle 3 with any desired point in space when a mounted camera is located between the bearing element 6 and a point whose direction is to be found. Here, the elongation tube 16m is inserted between the direction-finding device 16i and bearing element 6 such that the direction-finding device 16i “looks” to a certain extent over the mounted camera. On its underside, such an elongation tube 16m has a contact ring 16c that is likewise provided on its underside with downwardly pointing guide pins that engage positively in guide bores 16e of a bearing element 6. The contact ring 16c is permanently connected to a vertically extending tube body 16n that is permanently connected in turn at its top side to a further upper contact ring 16o that has two guide bores 16e corresponding to those in the bearing ring 6.

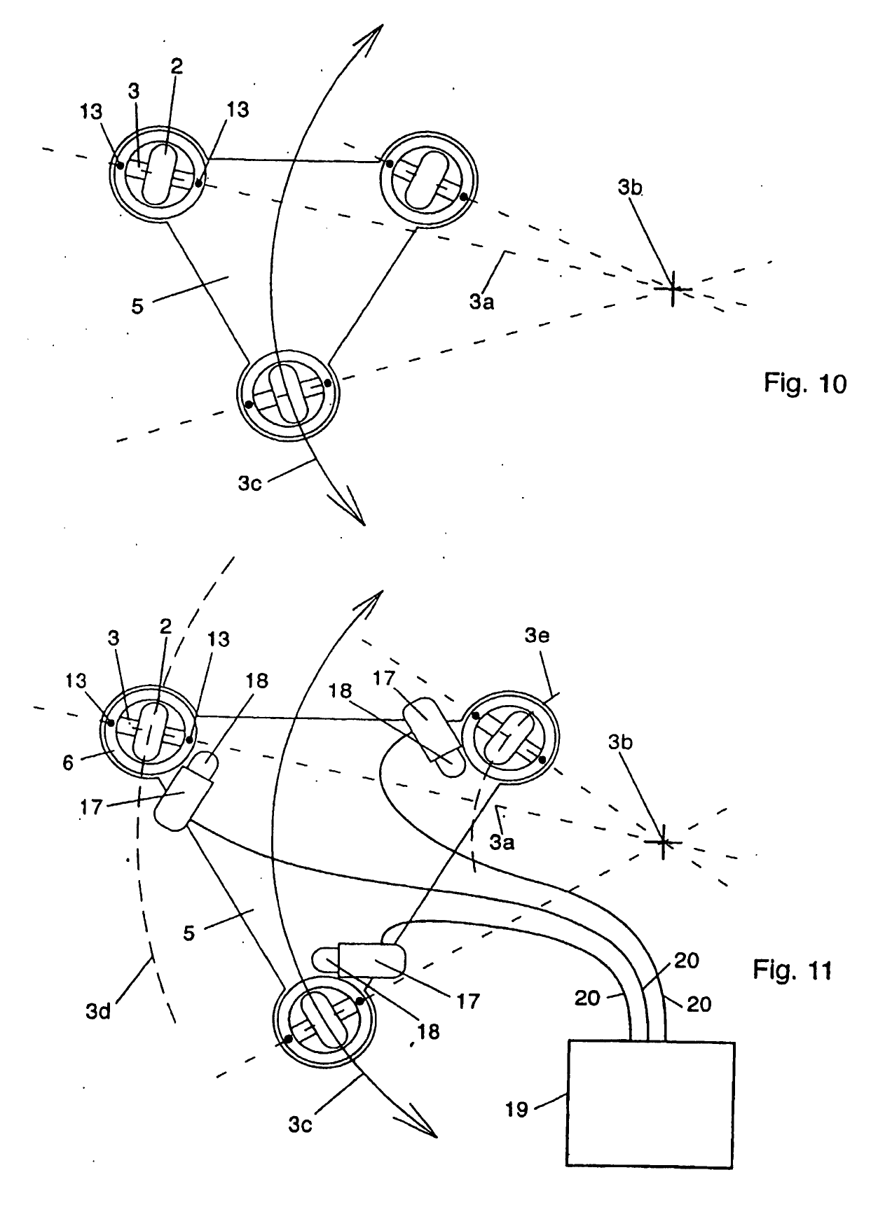

FIG. 10 shows a schematic of a circular movement of a camera head system about a point 3b in space. Here, all the caster axles 3 are aligned such that their imaginary elongations 3a intersect a point 3b. The marking and direction-finding elements 13 lying vertically above the caster axles 3 likewise coincide with this point 3b in space and, as described above, can be used to align the caster axles 3. Upon displacement of the entire unit, the latter executes a circular tracking movement 3c about the point 3b.

The possibility of being able to execute a circular movement of a camera about any desired point constitutes a substantial advance relative to the current prior art. With known camera tracking devices such as, for example, the dolly already mentioned, and proposed in WO 99751911 A1, it is currently only possible to carry out a curved movement about a point that lies either on a line that runs through the center of the two front wheels, or on a line, parallel thereto, through the mid point of the dolly (FIG. 47a and FIG. 47b). In addition, such a dolly has the disadvantages, already explained in detail, with regard to the possible vertical height of a camera and the overall size.

A further advantageous alignment of the casters is achieved when the running directions of all the casters 2 point to the center of the flat holding element 5, since any possibility of tracking is blocked in this position. In this case, the camera head system can be used without additional braking devices as a camera head of purely flat design.

FIG. 11 likewise shows a circular movement about an arbitrary point 3b in space. However, there is illustrated here a further running direction adjusting device in the form of positioning motors 17 that engage with a bearing element 6 via a gear 18 and thus control the rotary position of a caster axle 3. Via connecting cables 20, the positioning motors 17 are connected to a CPU 19 that produces the control commands for the motors 17. Such a CPU 19 could, for example, be a laptop or a PDA that can additionally be optionally connected to input devices (not illustrated in more detail) such as joysticks, cranks, tracker balls or computer mouse for controlling the positioning motors. It is also advantageously possible to imagine wireless data transmission between the CPU 19 and all existing positioning motors 17.

Of course, control with the aid of a CPU 19 for aligning the caster axles 3 is not limited here only to circular movements, but can equally be applied in the case of linear movements in any direction, and of other curved movements. In this case, it is advantageous when the CPU 19 ensures that all the casters 2 are in each case aligned either parallel to one another or such that the elongations of all the caster axles 3 intersect at a point.

A further advantageous development of this exemplary embodiment can be achieved when not only the rotary position of the bearing elements 6 are controlled with respect to the holding element 5 by means of motors 17, but also when the rotation of the casters 2 about their caster axles 3 is driven by further motors (not illustrated here) that are likewise driven by the CPU 19. It is advantageous here when the speed of each caster 2 is coordinated with the corresponding circular measure of the respective circular tracks 3c, 3d and 3e, since an optimum traction is achieved thereby.

Of course, it will also be desirable in the case of such an extensively motorized case of application to drive the panning movements and tilting movements of a camera at a panning apparatus via appropriate motors and the CPU 19.

FIG. 10 shows a section through a bearing arrangement with a caster 2 that is supported rotatably about a caster axle 3 that is mounted in a bearing element 6 that is supported rotatably about a vertical axis in an advantageous, additional supporting tube 7. The design illustrated here for a sliding bearing between the bearing element 6 and supporting tube 7 constitutes a particularly simple and cost-effective design and can also be designed otherwise. In the case illustrated, the bearing element 6 comprises two components 6a and 6b that are to be connected to one another and surround a guide on the inner surface of the supporting tube 7, and on whose top side a scale 11 is located.

The supporting tube 7 has on its outer surface an external thread that engages in a matchingly designed internal thread of the holding element 5. Located on the underside of the supporting tube 7 is an adjusting ring 7c whose surface has a good grip and can, for example, be of knurled or corrugated design, or else can have depressions or elevations and facilitates manual rotation of the supporting tube 7 in the holding element.

By means of the thread located between the supporting tube 7 and holding element 5, it is possible to detach a bearing element 6 together with the supporting tube 7 from the holding frame 5. Such a detachable connection constitutes a substantial advantage, particularly by virtue of the fact that it is possible to make use in a camera head system of different casters that will be presented in yet more detail below. Even if the aim is to dispense with the possibility of leveling a camera head system, it is therefore advantageous when at least one caster 2 together with its bearing is detachably connected to the holding frame 5. A further conceivable connection here is a bayonet lock, for example.

FIG. 13 shows a bearing arrangement of identical design in principle, although it has a clearly elongated supporting tube 7 and, moreover, the bearing element 6 is designed to be correspondingly longer such that here, as well, a scale 11 indicates the angle of rotation between the bearing ring 6 and holding element 5. The longer design is characterized by a modified spacing 8a between the region provided with a thread and the vertical position of the caster axle 3.

In the diagram of FIG. 14, a supporting tube 7 and possible locking devices are illustrated with the aid of which it is possible to lock a rotation of the supporting tube 7 in the holding element 5. In addition to the external thread 7a already explained and to an adjusting ring 7c designed with an outer surface of good grip, such a supporting tube 7 can have annular, for example vertical latching teeth 7b in which there engage the correspondingly designed teeth of an identical module of a locking pin 7d or a locking rocker 7e that are pressed against the supporting tube 7 by means of spring pressure 7g. The rotatability of the supporting tube 7 is unlocked by retracting the locking pin 7d or rotating the locking rocker 7e in a direction against the spring pressure.

Shown schematically in FIG. 15 is the side view of two camera rockers 42, 43 as used in a camera head system in FIG. 2 and already presented. It is possible to mount on the top side of such a rocker 42, 43 a camera whose optical axis is aligned parallel to the side walls. The side wall of such a rocker 42, 43 has on its underside an arcuately curved guide skid 31 whose convex outer surface 32 rests on two lower guide rollers 34 that are supported in the holding element 5. An upper guide roller 35 bears against the concave inner surface 33 of the guide skid 31 and prevents the rocker 42, 43 from falling inadvertently out of the system.

An arcuate groove 41 running parallel to the guide skid 31 is cut into the side wall and restricted at the sides in such a way that a locking bolt (not shown) resiliently supported in the holding element 5 engages in the groove 41 and laterally restricts the pivoting range of the rocker such that the latter cannot slide out of the region guided by the guide rollers 34 and 35. For changing purposes, such a locking bolt can be retracted so that it no longer engages in the groove 41.

Use may be made in this arrangement of rockers 42, 43 that are of lower design and have a smaller tilting range 42 and rockers 43 of higher design with a larger tilting range. Such a possibility of changing offers a cameraman the possibility of also influencing the height of a camera and its lens, and of exchanging these for one another if required. The width of a guide skid 31 between the inner radius 33 and outer radius 32 is always designed in this case so that the upper guide roller 35 and lower guide roller 34 touch the skid 31, it therefore being possible to exchange the rockers 42, 43 without readjusting the guide rollers 34, 35.

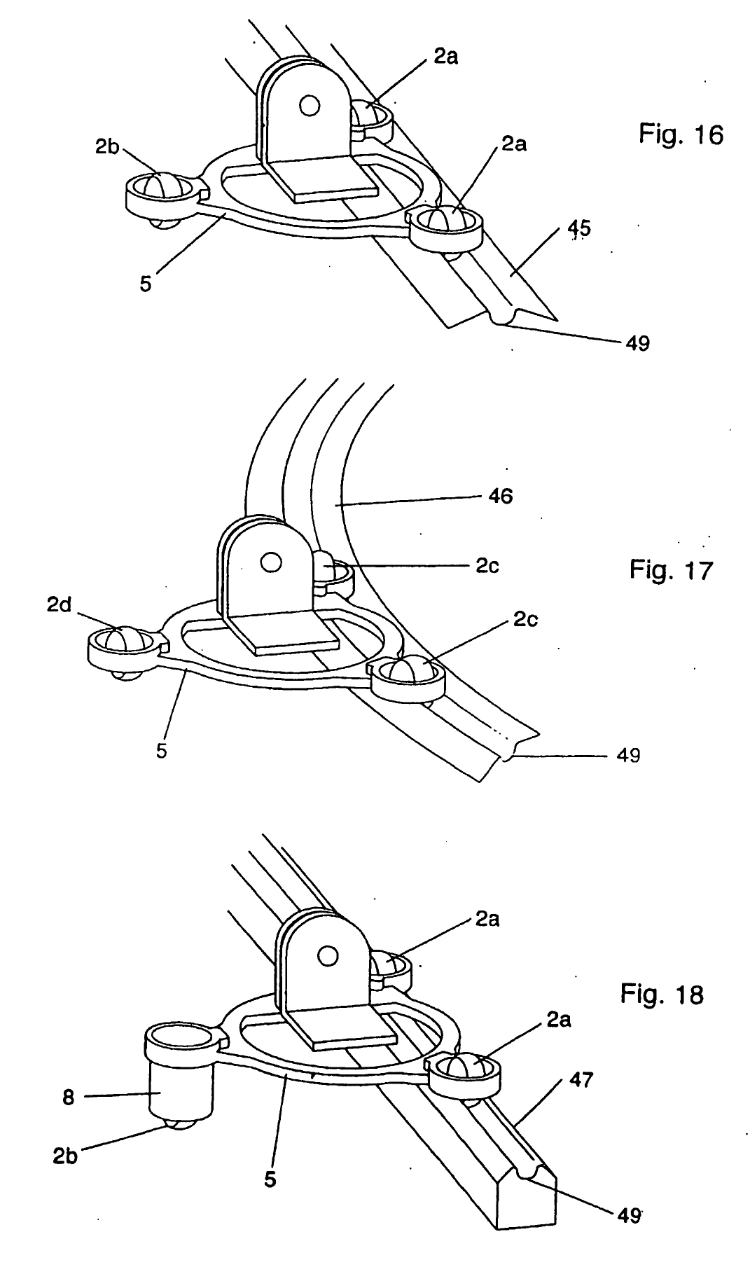

FIG. 16 to FIG. 19 show various configurations of guide profiles 45, 46, 47 and 48 in which it is possible to guide a camera head system according to the invention. Such guide profiles 45, 46, 47 and 48 offer the advantage of always being able to move on a precisely defined path, since it cannot be excluded that the exact travel path can vary slightly owing to frequent to-ing and fro-ing of an unguided camera head system. Should, therefore, a cameraman insist on an exactly repeated travel path, an arrangement with one 45, 46, 47 or two parallel guide profiles 48 will be advantageous.

In FIG. 16, two, mutually aligned casters 2a are guided in a flat rail section 45 provided with a U-shaped guide groove 49, a third caster 2b being aligned parallel to the two other ones and running unguided on the bearing surface. As described in the discussions relating to FIG. 6, the rotary positions of the bearing element 6 can easily be found for using a rail by means of special markings 11b on a scale 11 and/or by means of latching in perceptibly when rotating.

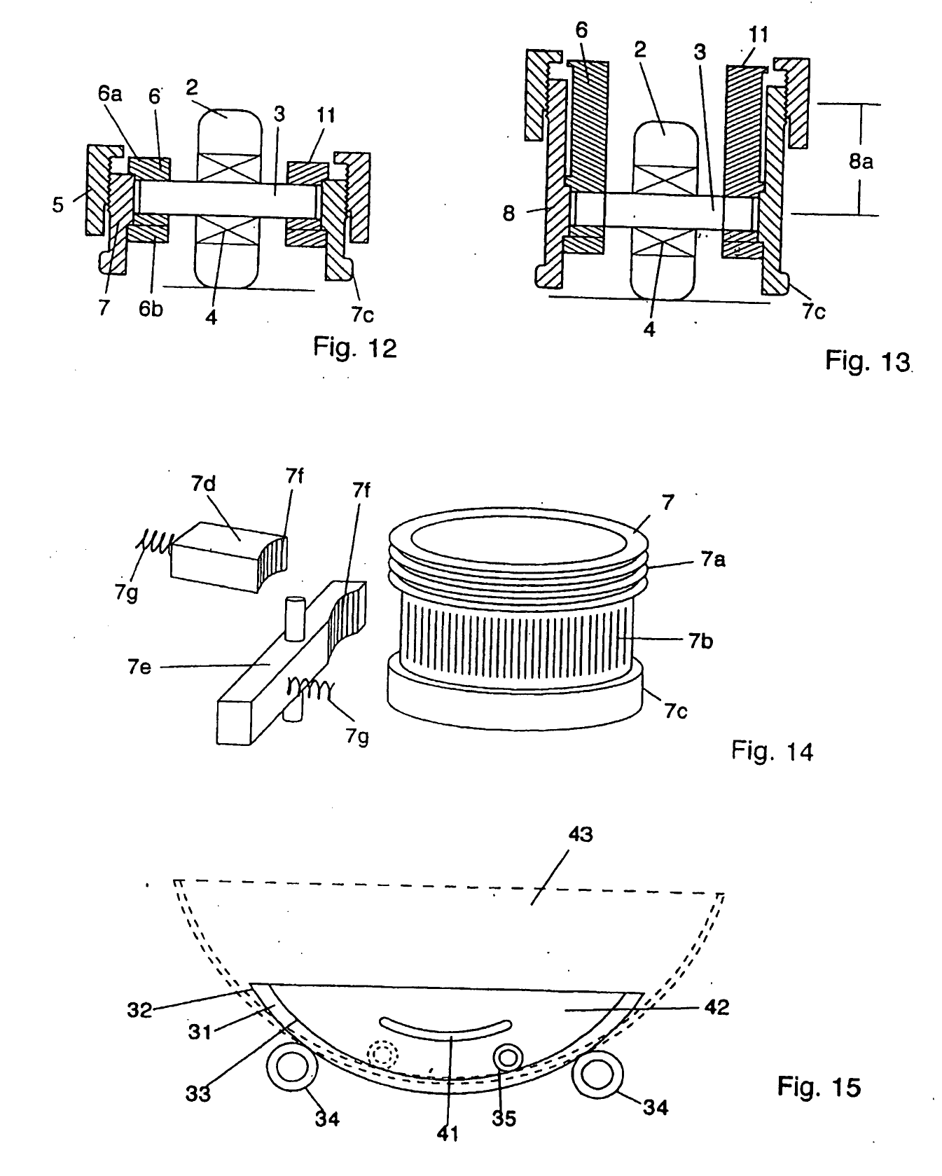

The rail section 45, 46 is designed such that it is of very flat design with reference to the contact area, particularly at the apex of the U-shaped guide groove 49, and thus leads to only a minimum tilting of the holding element 5 that can be brought level again via the supporting tubes 7 explained in more detail in FIG. 12, this being done by the supporting tube 7 of the caster 2, running freely on the underlying surface, being rotated in the thread so that the spacing between the holding element 5 and contact area is slightly enlarged.

Particularly in the case of inaccessible or confined film set, or in macro photography, it can be advantageous to be able to make use in a space saving fashion of only one rail section 45, 46, 47, since a cameraman will always be concerned rather to keep a setup small and neat. Nevertheless, it is also possible, of course, to conceive two rail sections 45 that run parallel to one another and are held at a suitable spacing from one another by means of spacers (not shown).

One rail section 45, 46 runs out at the lateral edges at a flat angle to the bearing surface and can be fixed on the underlying surface with the aid of an ordinary adhesive tape that is available on any film set. Such a section 45, 46 can be produced cost-effectively in one piece and from one material, for example it is possible to conceive a design made from folded sheet metal.

FIG. 17 shows a rail curve 46 having the flat design features of a straight section 45 from FIG. 16, in the case of which the two track wheels 2c guided in the section are adjusted so that they are aligned along the U-shaped guide groove 49. The caster 2d resting freely on the underlying surface has an alignment parallel to the rail section 46.

FIG. 18 shows an arrangement of a camera head system in the case of which two casters 2a aligned with one another are guided in a rail section 47 of higher design that likewise has a U-shaped guide groove 49 in the guiding region. The non-guided caster 2b resting on the underlying surface is aligned parallel with the rail section 47 and supported in a supporting tube 8 of elongated design in such a way that the elongated design compensates for the difference in height of the rail section 47. By rotating the supporting tube 8, which engages with an external thread in an internal thread in the holding frame 5, it is possible to achieve a fine adjustment for the purpose of leveling the holding element 5. Of course, a rail section 47 of such a higher design can also be conceived as a curved design. Likewise, it should advantageously be possible to join rail sections 47 to one another so as to be able to use rail guides of any desired length.

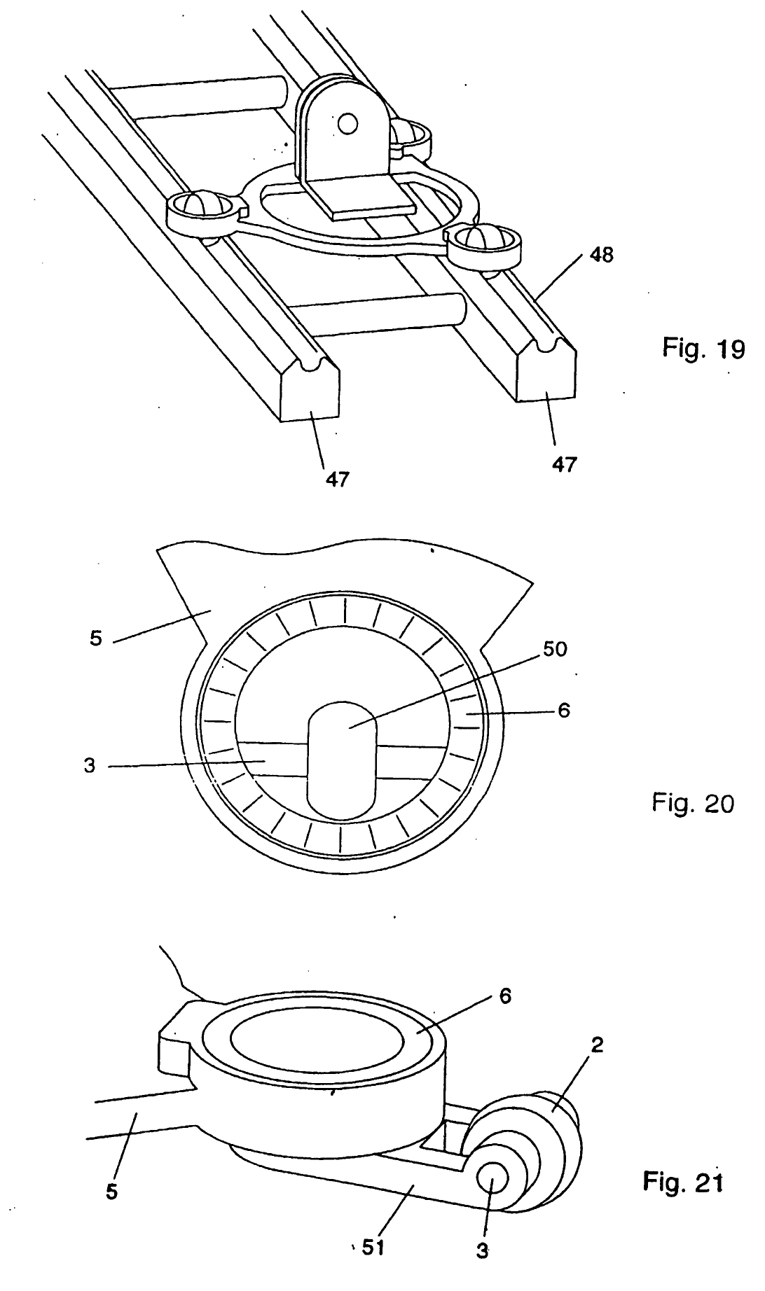

FIG. 19 shows two rail sections 47 of higher design that are permanently connected to one another to form a double rail 48 and which run parallel to one another. These respectively have a relatively large cross section, it being possible, for example, to design the rail section 47 as an extruded box-type section which therefore exhibits little deflection, even in the case of self-supporting assembly. The possibilities of such a system are extended not inconsiderably by the fact that suitable stands or supporting apparatuses such as, for example, lighting stands or stage platforms, can be used to set up such a configuration at any desired height. It is likewise desirable in this case to be able to connect a number of double rails 48 to one another and so achieve any desired tracking length. A curved design is also conceivable as such a double rail.

FIG. 20 shows a schematic plan view of a caster axle arrangement that differs from the already explained arrangement shown in FIG. 6 in such a way that a relatively small caster 50 is used here, and the caster axle 3 is no longer mounted in the center of the bearing element 6. If, in addition, the bearing is of freewheeling design between the bearing element 6 and holding element 5, such a caster 50 will be aligned in the running direction as the system tracks, and this can be advantageous for steering movements.

FIG. 21 shows an alternative design of the arrangement presented in FIG. 20. Here, a caster 2 is supported rotatably about a caster axle 3 that is mounted in an axle fork 51, this axle fork 51 being permanently connected to the bearing element 6, which is supported in the holding element 5 such that it can rotate horizontally in a freewheeling fashion. Such a caster 2 will also align itself in the running direction as the system tracks if it does not collide with the holding element 5. It is advantageous in this case that there is no need to have recourse to relatively small casters 2 in the case of which, for example, instances of slight unevenness on the underlying surface would be perceptible on being traveled over.

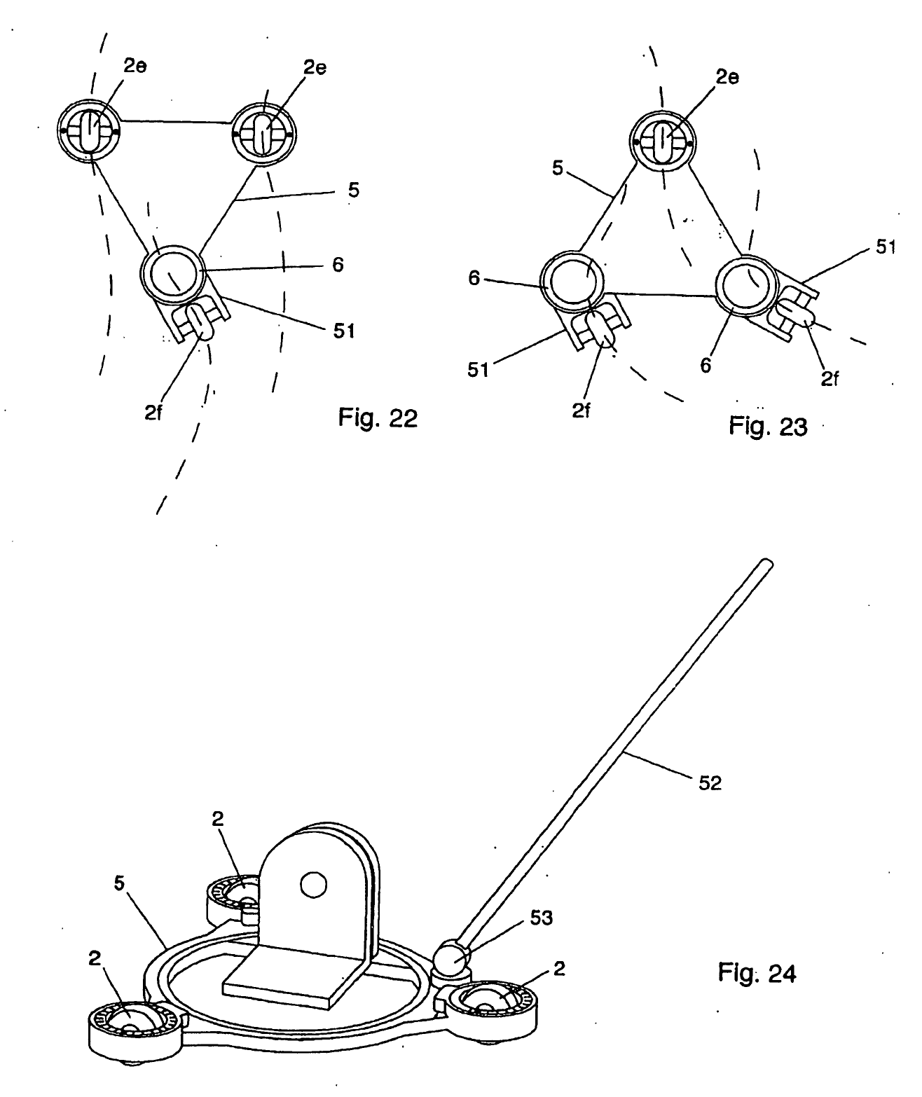

FIG. 22 shows a schematic of a camera head system that has two mutually parallel casters 2e locked in their horizontal rotation, and a caster 2f which is supported in a holding fork 51, as explained in more detail above, this holding fork 51 being permanently connected to a bearing ring 6 that can rotate freely about a vertical axis with reference to the holding element 5. So that it does not collide with the holding element 5, this caster 2f lying outside the holding element 5 will align itself in the direction of travel during a tracking movement. The system can not only track in a predetermined direction, but also be steered by means of an appropriate lateral pressure on the holding element 5.

FIG. 23 shows a similar arrangement in which steering movements are likewise possible. Shown here is a camera head system that has one caster 2e that is locked in its horizontal rotation, and two casters 2f that are supported in holding forks 51, these holding forks 51 being permanently connected to a bearing ring 6 that can be rotated freely about a vertical axis with reference to the holding element 5.

FIG. 24 shows a camera head system with a mounted guide rod 52 that is connected to the holding element 5 via a guide bearing 53. Such a guide bearing 53 is designed so that the guide rod 52 can be pivoted freely with respect to the holding element 5 about a horizontal axis in the guide bearing 53. Here, the rotary position of the guide rod 52 can be set and locked about a vertical axis in the guide bearing 53. It is also possible via a suitable device (not shown) to unlock the guide bearing 53 so that the guide rod 52 can be pivoted freely both in the horizontal and the vertical direction.

Such a guide rod 52 enables a cameraman to guide a camera head system in an upright posture when said system is to travel over the ground, for example. Such a guide rod 52 can be helpful even in inaccessible objects such as, for example, a shaft or a passageway. If the aim here is for a camera to describe a previously set, precisely defined tracking path, or if a camera head system is additionally guided by rails, it is desirable to adjust the guide rod 52 so that the latter can be freely pivoted in the horizontal direction, and equally in the vertical direction so that a precise, prescribed tracking path is ensured by the casters 2, which are preset in their horizontal rotation.

If the aim is also to steer a system via the caster arrangements explained in more detail in FIG. 22 and FIG. 23, it is advantageous when the ability of the guide rod 52 to pivot about a vertical axis in the guide bearing 53 is locked, since in this way the steering movements of the guide rods 52 can be transmitted to the holding element 5. An ability to pivot freely about a horizontal axis in the guide bearing 53 is advantageous because it prevents a caster 2 from inadvertently lifting off owing to lever action of the guide rod 52.

It is also advantageous for the execution of steering movements with the aid of a guide rod 52 when the rotary position of the guide rod 52 about a vertical axis in the guide bearing 53 can be set and locked. A cameraman can thereby select an optimum position for himself or for the subject.

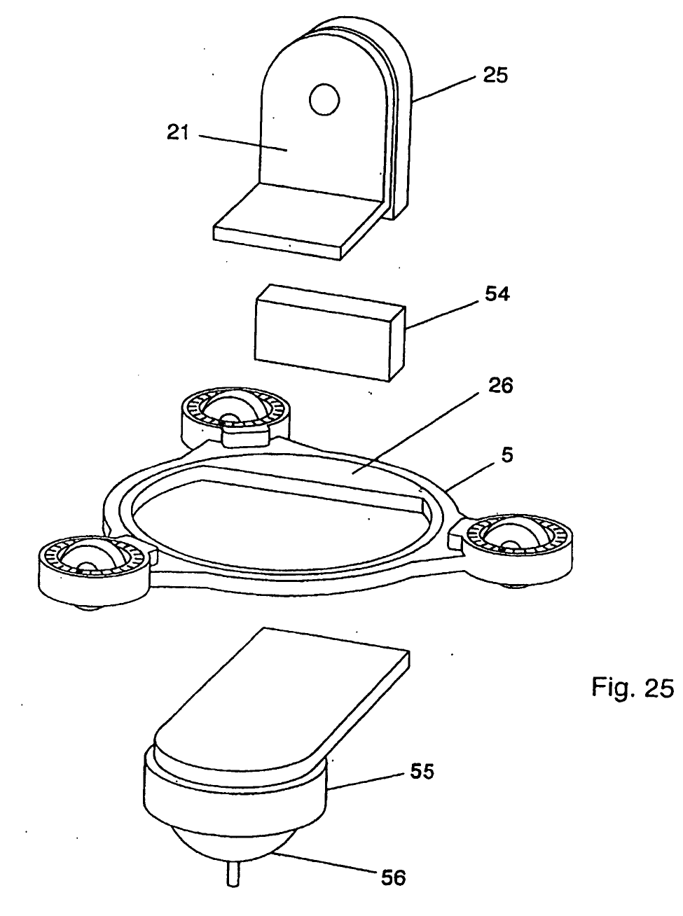

FIG. 25 shows an advantageous development of a camera head system having an L-shaped camera holder 21 that can be rotated about a horizontal axis with reference to a fastening column 25. The fastening column 25 is connected removably to the horizontal panning ring 26, or directly to the holding element 5. Such a fastening column 25 can be elongated with the aid of a column block 54, for example, as a result of which higher camera positions can be achieved.

It is likewise possible for the possibilities of using such a camera head system to be extended by virtue of the fact that a removed fastening column 25 can be mounted together with the L-shaped camera holder 21 on a horizontal panning module 55 that has on its underside a customary interface 56 with the aid of which camera heads are fastened on holding devices such as stands, for example. This renders it possible to be able to configure a commercially available camera head with the aid of only one additional horizontal panning module 55, and to use the tilting unit, comprising the fastening column 25, and an L-shaped holder 21, for both applications in this case. The result therefore is substantially lower procurement costs than would need to be applied for procuring a camera head system and a conventional camera head.

1-32. (canceled)

33. A pan headcamera head system comprising a camera being mounted at a substantially flat holding element on which there are mounted at an angular spacing about an imaginary vertical axis at least three casters rotating respectively about horizontal caster axles, at least one of said caster axles being adapted to be rotated and fixed in a horizontal plane in any desired rotary position, at least one running direction adjusting device being provided for adjusting said desired rotary position of said at least one caster axle.

34. The pan headcamera head system as claimed in claim 33, wherein said camera is mounted on a panning apparatus for carrying out vertical tilting movements and/or horizontal panning movements of said camera, said panning apparatus being mounted in or on said flat holding elementmovie.

35. The pan headcamera head system as claimed in claim 33, wherein said camera is mounted on a panning apparatus adapted for fixing said camera at a predetermined camera angle.

36. The pan headcamera head system as claimed in claim 33, wherein said running direction adjusting device comprises a scale that indicates said rotary position of said running direction of said at least one caster axle with reference to said holding element at a reference mark.

37. The pan headcamera head system as claimed in claim 36, wherein said scale has at least one special marking for indicating a position in which said casters are panned by (30+x*60)° relative to a main axis of said panning apparatus, where x can be a whole number between 1 and 5.

38. The pan headcamera head system as claimed in claim 33, wherein said running direction adjusting device comprises a digital display that indicates said rotary position of said at least one caster axle in said horizontal plane with reference to said flat holding element.

39. The pan headcamera head system as claimed in claim 33, wherein said rotary position of said at least one caster axle in said horizontal plane with reference to said flat holding element is determined by means of an incremental encoder.

40. The pan headcamera head system as claimed in claim 33, wherein said running direction adjusting device comprises direction-finding elements for aligning said caster axle in a direction of an imaginary point.

41. The pan headcamera head system as claimed in claim 33, wherein said running direction adjusting device comprises markings for aligning said caster axle in a direction of an imaginary point.

42. The-pan headcamera head system as claimed in claim 33, wherein said running direction adjusting device comprises at least one motor for adjusting said desired rotary position of said at least one caster axle.

43. The pan headcamera head system as claimed in claim 42, wherein said at least one motor is controlled by a CPU.

44. The pan headcamera head system as claimed in claim 33, wherein all of said caster axles are adapted to be rotated and to be fixed in said horizontal plane in any desired rotary position.

45. The pan headcamera head system as claimed in claim 33, wherein said casters can be locked in a rotating direction thereof.

46. The pan headcamera head system as claimed in claim 33, wherein an adjusting device is provided for adjusting a friction between at least one of said casters and a caster axle thereof.

47. The pan headcamera head system as claimed in claim 46, wherein a damping device is provided for damping a friction between at least one of said casters and said caster axle thereof.

48. The pan headcamera head system as claimed in claim 37, wherein a damping level of said damping device is adjustable.

49. The pan headcamera head system as claimed in claim 33, wherein three of said casters are provided and arranged at an angular spacing of 1200 about said vertical axis.

50. The pan headcamera head system as claimed in claim 33 comprising at least one bearing element in which one of said caster axles is fitted, said at least one bearing element being detachably connected to said holding element.

51. The pan headcamera head system as claimed in claim 33, wherein at least one of said caster axles is supported in a bearing ring element provided on an outside of said holding element, such that it can rotate in said horizontal plane.

52. The pan headcamera head system as claimed in claim 33, wherein a rotary movement of at least one of said casters about a caster axle thereof can be driven by means of a motor.

53. The pan headcamera head system as claimed in claim 52, wherein a speed of said rotary movement is controlled by a central CPU.

54. The pan headcamera head system as claimed in claim 34, wherein said horizontal panning movements and/or said vertical tilting movements of said camera in said panning apparatus are performed by means of motors that can be controlled by a central CPU.

55. The pan headcamera head system as claimed in claim 33, wherein said panning apparatus is removable from said holding element.

56. The pan headcamera head system as claimed in claim 33, wherein said panning apparatus comprises an L-shaped holder for mounting said camera, said L-shaped holder being mounted such that it can pan about a horizontal axis on a fastening column.

57. The pan headcamera head system as claimed in claim 56, wherein said fastening column is mounted on a bearing ring that is supported in said holding element such that it can rotate about a vertical axis and which has an annular opening that is designed such that a mounted camera and said L-shaped holder can pan, or partially pan, through.

58. The pan headcamera head system as claimed in claim 56, wherein said fastening column can be removed together with said L-shaped holder.

59. The pan headcamera head system as claimed in claim 33, wherein an exchangeable rocker is mounted on said holding element, said exchangeable rocker having on its underside at least one arcuately curved guide skid that rests with a convex outer surface thereof on at least two lower guide rollers arranged at a spacing from one another, and touches at least one upper guide roller with a concave inner surface thereof.

60. The pan headcamera head system as claimed in claim 33, wherein said at least one caster axle is supported such that it rotates in said horizontal plane about a vertical axis that lies outside a center of said caster.

61. The pan headcamera head system as claimed in claim 33, wherein a guide rod is mounted with one end on said holding element such that it can be pivoted about a horizontal axis.

62. The pan headcamera head system as claimed in claim 61, wherein said guide rod is mounted at one end on said holding element such that it can rotate about a vertical axis, a rotary position of said guide rod being adjustable and lockable.
